(19) United States
(12) Patent Application Publication
(10) Pub. No.: US 2004/0237859 A1
(43) Pub. Date: Dec. 2, 2004

(54) Method for processing waste products and corresponding processing plant

(76) Inventor: Rudolf Hartmann, Gelterkinden (CH)

Correspondence Address: Jay G Durst, Boyle Fredrickson Newholm Stein & Gratz, 250 E Wisconsin Avenue, Suite 1030, Milwaukee, WI, 53202, US

(21) Appl. No.: 10/488,722

(22) PCT Filed: Sep. 3, 2002
(86) PCT No.: PCT/EP02/09855

(30) Foreign Application Priority Data
Sep. 3, 2001 (DE) 101 42 906.1

(51) Int. Cl. F23B 7/00; F23G 5/12

(52) U.S. Cl. 110/341; 110/229

(57) ABSTRACT

Disclosed are a method for processing residual waste and other organically contaminated waste substances, and a residual waste processing plant, wherein a waste substance containing organic constituents is heated to the boiling temperature range of water in a reactor under vacuum, so that membranes of water-containing cell structures are destroyed, and the organically highly contaminated cell water may be discharged, together with the exhaust vapor.

The invention concerns a method for processing waste substances in accordance with the preamble of claim 1 and a residual waste processing plant in accordance with the preamble of independent claim 13.

The utilization of waste matter such as, e.g., domestic waste, industrial waste, organic waste, etc., is prescribed by legislation in the waste regulations, and whenever possible has to be preferred to waste disposal. The waste regulations fundamentally apply to any holder of waste as well as to public corporations subject to the duty of disposing of waste such as cities and communal cleaning services, for instance. Waste regulations and the German Federal Immission Protection Regulation (BIMSCHV) specify that waste has to be collected, transported, stored intermediately, and treated in such a manner that the options of waste utilization will not be impeded. In order to comply with this utilization duty, utilization in terms of material and energy are available to the communities.

Material utilization signifies processing of the waste matter into a secondary raw material which will then be exploited in terms of energy economy. In other words, production of the substitute fuel is considered to constitute a material utilization which has to be differentiate from immediate combustion of the waste. At present, the alternative named last is the type of waste utilization employed most frequently. It is, however, problematic in this thermal utilization that the limit values defined by the legislator have to be observed particularly in flue gas, so that considerable expenditure must be incurred in terms of installation technology in order to satisfy the legislative specifications. Moreover there is an ongoing public discussion concerning conventional waste incineration plants, for which reason the communities strive to supply the waste to a material utilization.

DE 196 48 731 A1 describes a waste processing method wherein organic constituents of a waste fraction are washed out in a percolator, and the residue thus biologically stabilized is incinerated following drying. This combustion takes place in a conventional waste incineration plant, so that there are the same problems with regard to the exhaust gases as in the thermal utilization described at the outset.

DE 198 07 539 describes a method for thermal treatment of residual waste, wherein a fraction having a high calorific value is obtained from the waste matter by mechanical and biological treatment. This fraction having a high calorific value is supplied as a substitute fuel to a combustion of a plant that is operated while energetically coupled with an energy intensive plant. As an alternative, this substitute fuel may also be used directly in the energy intensive plant. In this known solution, biological stabilization takes place through aerobic decomposition of the organic matter of the processed waste.

DE 199 09 323 A1 discloses a method for processing residual waste wherein the latter is supplied to aerobic hydrolysis. In this aerobic hydrolysis, the fraction to be stabilized biologically is subjected to air and a leaching fluid (water) in a reactor. The action of atmospheric oxygen and the concurrently adjusted humidity results in aerobic, thermophilic heating of the mixture of substances, so that the organic cells are broken up, and the released organic substances are transported off by the washing liquid. In this known reactor, the mixture of substances is carried through the reactor transversely to air and to the leaching fluid by means of a conveying/stirring system.

This aerobic hydrolysis exhibited excellent results in initial experimental plants whereby it is possible, at comparatively low expense in terms of device technology, to produce a substitute fuel that may not be eluted, has no breathing properties, and is characterized by a high calorific value. This substitute fuel may, for instance, be supplied to gasification, and the resulting gas may subsequently be employed energetically or materially in power plants and cement factories, or in the production of methanol or as a reducing agent in steel factories.

In the above described waste utilization method a high expense in terms of device technology is, however, still necessary for carrying out aerobic hydrolysis, so that the like plants require much space on the one hand and are comparatively costly on the other hand. Thus large amounts of highly contaminated exhaust gases are produced and have to be supplied to a complicated and costly gas purification and combustion in accordance with the 30th BIMSCHV.

In contrast, the invention is based on the objective of furnishing a method for processing waste substances and a processing plant, whereby stabilization of the residual waste may be carried out at reduced expense in terms of method and apparatus.

This objective is achieved by the features of claim 1 with regard to the method, and by the features of claim 13 with regard to the processing plant.

In accordance with the invention, a thermal stabilization of waste matter is carried out in a reactor operated approximately in the boiling range of water under a vacuum. Owing to operation in vacuum, there is practically no generation of exhaust gases, and the residual substances may be handled and stored as a product in a dry-stable and hygienic manner.

Due to the manner of operating the reactor in accordance with the invention, decomposition of the organic cells may be accelerated substantially by the biological digestion in comparison with the conventional percolation processes described at the outset, so that furthermore only a fraction of hitherto customary material processing periods is necessary. This makes it possible to give the reactor a substantially more compact design, wherein in accordance with first preliminary tests the reactor volume amounts, at identical throughput, to no more than about 5% of a previous percolator.

Thermal treatment of the organic constituents of the residual waste in the boiling range of water leads to an explosive destruction of the membranes of the water-containing cell structures, and the released, organically highly contaminated cell water may be extracted from the reactor. Owing to heating and the action of vacuum inside the reactor, the constituents are sanitized and may be handled without any objections in terms of human medicine.

Due to the fact that the boiling temperature is lowered by vacuum below the fusion point of plastic components of the waste substance, the plastic parts cannot undergo melting during boiling extraction or boiling drying to thereby soil inner peripheral walls of the receptacle and as a result deteriorate heat transfer.

In an advantageous variant of the method of the invention, the reactor is operated as a boiling extractor, wherein a leaching fluid is applied to the residual waste that was heated to boiling temperature, so that the organically contaminated constituents of the residual waste are washed out. Preliminary tests showed that in such a boiling extractor even nitrogen present in the residual waste is expelled in the form of ammonia. Owing to expulsion of ammonia, the nitrogen load of the residual waste is reduced to such an extent that removal of nitric oxides need not be performed in subsequent method steps, e.g. in processing of organically contaminated leaching fluid in a biogas plant.

The proportion of organic matter in the residual waste may be further reduced if boiling extraction is followed by a boiling drying in which the thermally stabilized residual waste present after boiling extraction is supplied to a reactor in accordance with the invention, in which case, however, no leaching fluid is supplied but merely a thermal stabilization by heating the already pre-stabilized residual waste is carried out in the boiling range under vacuum.

Effectivity of the method is enhanced further if boiling drying and/or boiling extraction is preceded by a pre-heating so that less heating energy needs to be supplied to the reactor in order to heat the residual waste to the boiling temperature.

With a suitable composition of the residual waste it may also be sufficient to perform thermal stabilization by a boiling extraction or a boiling drying only, preferably preceded by a respective pre-heating stage.

This pre-heating is preferably carried out by an aerobic retting process. In the case of such an aerobic heating a biologically generated hydrolysis takes place which biochemically accelerates cell digestion and thus raises the leaching rate in a subsequent extraction, or raises the dehydration in a subsequent drying, respectively.

The exhaust vapor occurring downstream from the boiling extractor or boiling dryer is in one advantageous embodiment cooled with the aid of a condenser or of means having an equivalent effect and is thus condensed, so that the process may be carried out essentially in the absence of waste air apart from slight leaked air.

The potentially occurring leaked air may at minimum expense in terms of method technology be burnt in a burner or supplied to further processing such as a waste air purification plant.

As was already mentioned, the organically contaminated leaching fluid occurring after boiling extraction may be supplied to a biogas plant.

Fermentation water freed from its load in the biogas plant is preferably recycled to the boiling reactor as cycle or process water. The generated biogas may be used for generating process heat in the reactor or for generating electric energy, so that the system may be operated essentially autonomously as regards energy.

In a preferred embodiment the warm dry matter present after boiling drying is supplied to waste air-free cooling drying, so that the warm dry matter is once more dehumidified by the concurrent lowering of the dew point.

The basic module of the residual waste processing plant in accordance with the invention fundamentally consists of a heatable reactor operable under vacuum and designed to include a residual waste or material feed and a material discharge, as well as a stirring device for conveying the residual waste and for the introduction of shear forces.

This reactor may be operated as a boiling extractor when leaching fluid is supplied and as a boiling dryer without leaching fluid.

The stirring device of the reactor is preferably performed in such a way that the stirring members thereof strip off material adhering to the inner peripheral walls of the reactor during one revolution, so that encrustations on the wall surfaces are avoided. Owing to the effect of the stirring device, the material is shifted along the heated inner peripheral surface wall and transported from the material feed to the material discharge, optionally in the opposite direction.

The stirring device preferably has the form of a worm gear, wherein the worm gear may be designed with or without a center shaft.

The drive mechanism or the stirring device is preferably designed to have a reversible direction or effect, so that the conveying direction may be reversed.

The effect of the stirring device is particularly good if the stirrer is designed to be heatable.

In a preferred embodiment, the residual waste and the leaching fluid are supplied through a common material feed.

The reactor may be given a very compact design if it is provided with two sections having one respective stirrer arranged therein. These two sections may be interconnected through a suitable material advance or a reverse material advance, so that the material may be supplied into the circulation.

In a preferred variant of the method, the thermally stabilized waste fraction is supplied to a press, with the organic constituents contained in the press water being converted in a biogas plant.

Thanks to the above described circulation of the substance flows occurring in waste processing and contaminated with biological constituents, even the strictest specifications by the legislator as prescribed, e.g., in the 30th BIMSCHV, are satisfied at comparatively low expenditure, for there is no need for downstream arrangement of any costly purification steps for waste air and effluent incurred.

As an energy generator for heating the reactor it is possible, e.g., to use a burner, a gas turbine, or a gas engine to which the above mentioned flows of substances, such) as the biogas occurring in the biogas plant, the organically contaminated waste air occurring in the boiling reactor, or the waste air occurring in the dehydration of the waste are supplied for residue-free combustion.

Further advantageous developments of the invention are subject matters of the further subclaims.

In the following, preferred embodiments of the invention shall be explained in more detail by making reference to schematic drawings, wherein:

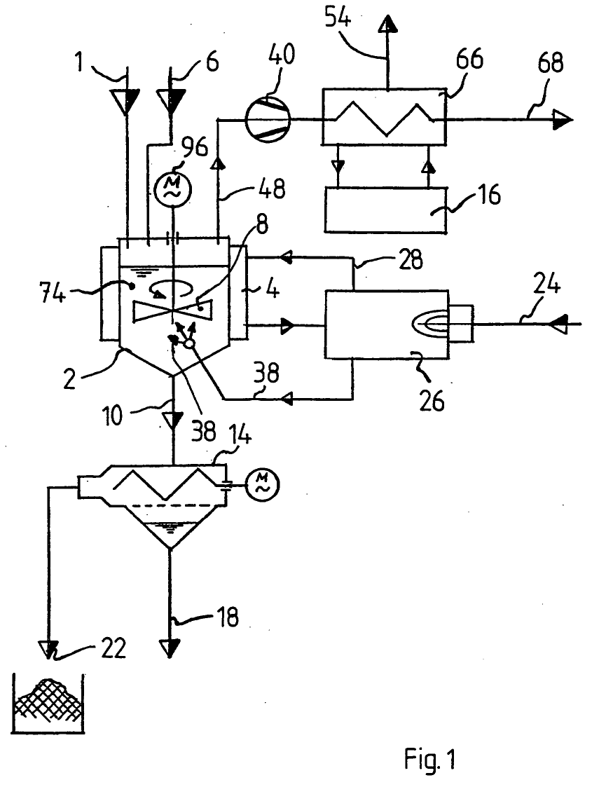

FIG. 1 shows a method diagram of a basic module for processing residual waste by a boiling extraction;

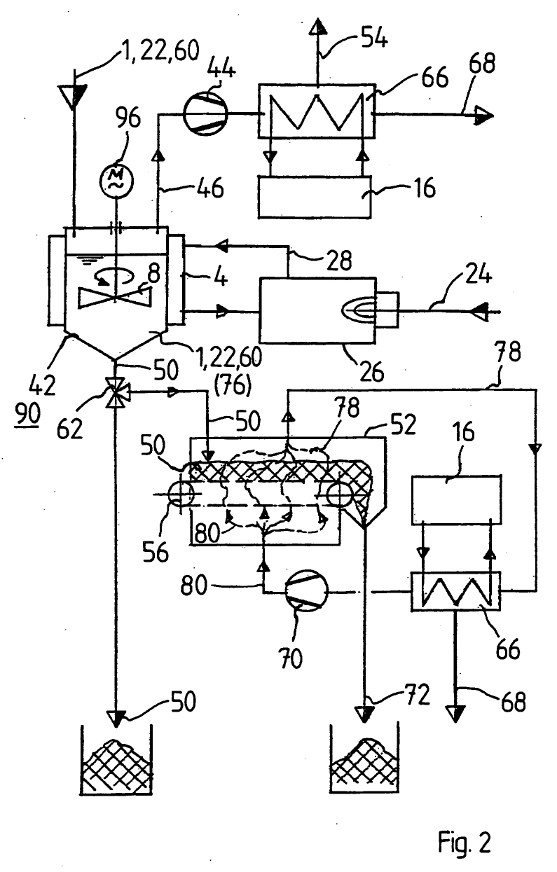

FIG. 2 shows a basic module of the method of the invention for processing residual waste by a boiling drying;

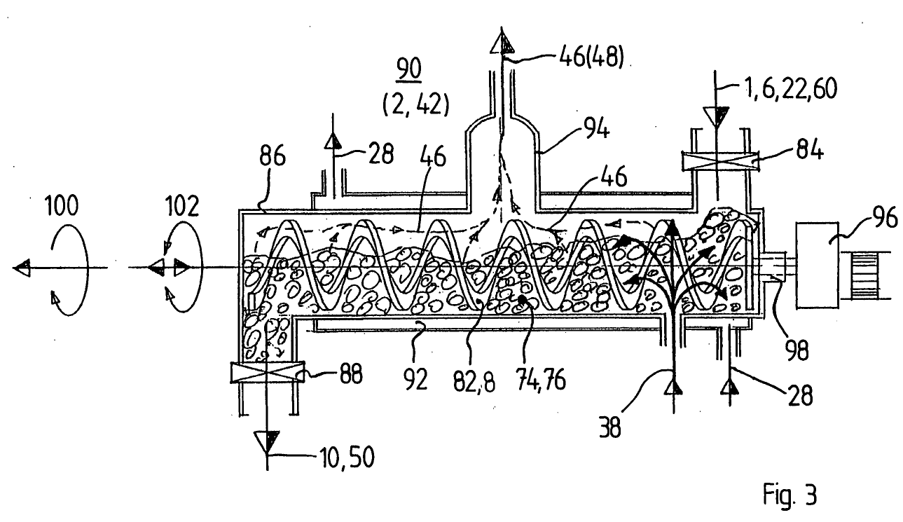

FIG. 3 shows a reactor for use in a method in accordance with FIGS. 1 and 2;

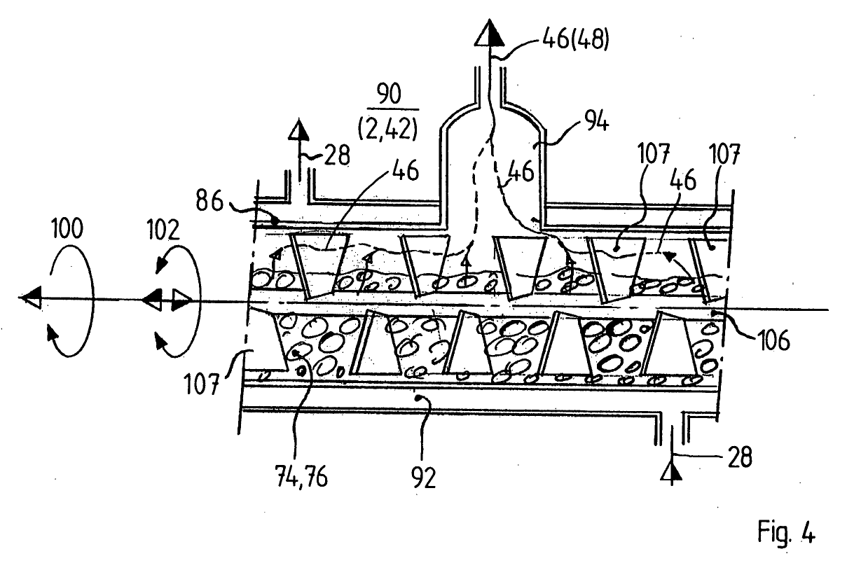

FIG. 4 shows an embodiment of the reactor in FIG. 1;

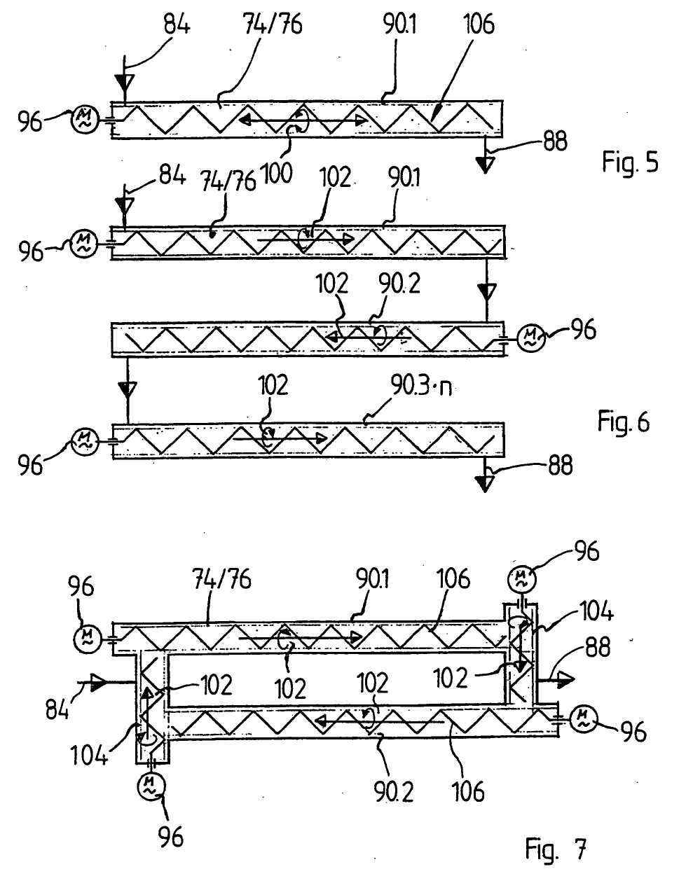

FIGS. 5, 6, 7 are schematic representations for the combined arrangement of reactor sections for a boiling extraction/boiling drying; and

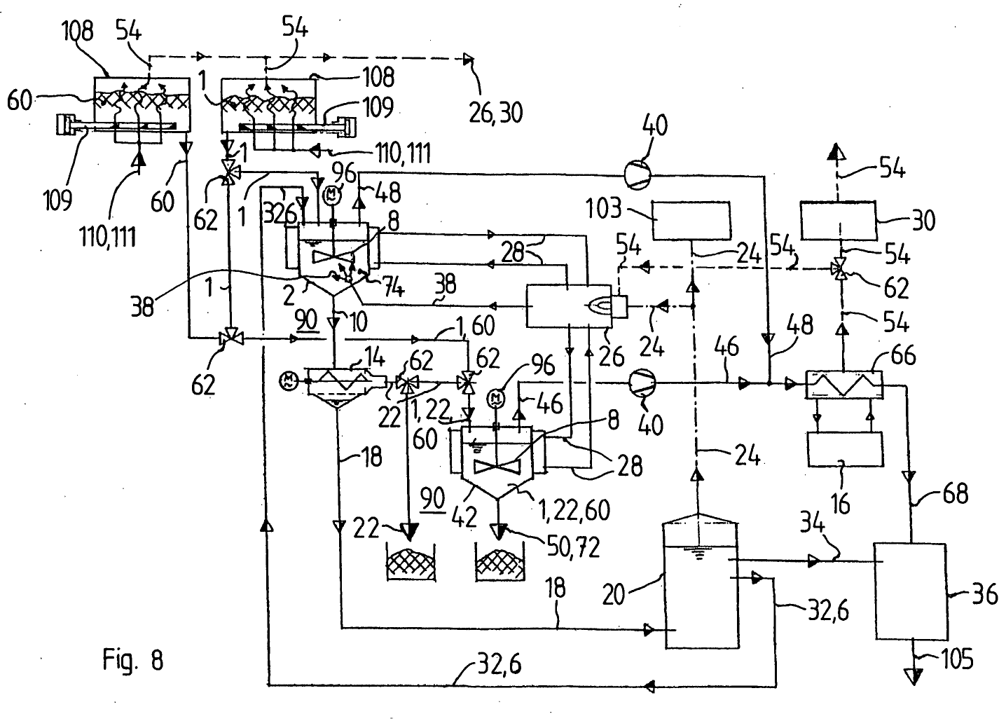

FIG. 8 shows a basic principle of a method for processing residual waste by a boiling extraction and subsequent boiling drying.

FIG. 1 schematically shows the basic principle of minimum equipment for performing a boiling extraction process for the treatment of organically contaminated waste substances such as, e.g.:

residual waste

canteen wastes

wastes from the food industry

vegetables and other replenishable organic waste substances

sewage and fermentation sludges

biological residues, such as mashes, from production of beverages

The organically contaminated substances 1 are supplied to a reactor 2 and diluted with fresh water or circulation liquid 6. With the aid of a stirring device 8 the suspension 74 of waste matter and liquid is mixed and transported. Heat supply for reaching the boiling temperature is carried out by a jacket heating 4.

In order to accelerate the heating process, it is also possible to jointly introduce pressurized steam 38 directly into the suspension 74 and/or through an upstream heating stage not represented in detail.

A substantial proportion of this residual waste consists of short-chain compounds which are mostly absorbed on the surface. If this surface is washed by the hot process water, primarily insoluble compounds are hydrolyzed and washed out. The odor-intense components of the organic waste and the hydrolysis products have relatively good solubility in water and may be washed out through the leaching fluid. By such an extraction a reduction of the organic matter and a deodorization of the residual waste is obtained.

By operating he boiling extractor in the range of the boiling point of the water under vacuum, the physical/chemical effect or the extraction is enhanced substantially by increasing bacterial decomposition. The organic cells of the mixture of substances are broken up and cell water is released, and the dissolved organic matter is transported off by the leaching fluid. It was found that through use of a boiling extractor 2 instead of a conventional percolator, the processing time is reduced from approximately two days for conventional percolators to two hours, so that the boiling extractor 2 may be designed with a substantially smaller volume than conventional percolators in order to process the same throughput of waste matter.

The process heat processing is performed through a heat generation plant 26 whereby the heat energy 28 is generated in the form of warm water, pressurized hot water, thermo-oil or steam 38.

As the energy carrier 24 supplied to the heat generation plant it is possible to employ biogas autogenerated in the process, and/or to also use other fossil fuels or electric energy.

During the boiling step in the boiling extractor 2, the boiling point is maintained distinctly below 100° C. owing to the reduced pressure, and the jacket temperature 4 is, in accordance with the suspension 74, set to a temperature level at which encrustations at the heating surfaces do not occur in order for the heat transfer in the suspension 74 being able to take place without any losses.

Depending on a product mixture/suspension 74, constituents such as, e.g., plastic parts and plastic sheets may already begin to plastify and coat the heat transfer surfaces and the stirring device 8 with a highly viscous layer at heating jacket or surface temperatures 4 around 80° C. The reduced pressure is generated by a vacuum generator 4 (here represented as a vacuum pump) which lowers the boiling point in the boiling extractor 2 to <60° C. by the generated reduced pressure of preferably ≦80 mbar.

The constituents exiting via exhaust vapor 48 are cooled below the dew point in a exhaust vapor condenser 66 by cooling 16, and the exhaust gases 54 are separated from the condensate 68. The vacuum generator 40 may, depending on requirement, be arranged upstream or downstream of the exhaust vapor condenser 66.

The exhaust gases 54 occurring at the exhaust vapor condenser contain leaked air and mixtures of inert gases from the heated suspension 74 and amounts of residual gas from circulating water 6 of a biogas plant described in more detail hereinbelow. The occurring amounts of waste gas are less than 1.0 m³ for an amount of treated suspension of 1000 kg and are thus extremely low, so that it is possible to speak of a waste air-free process in practice.

As a result of the suspension temperature between >40° C. and <100° C. and the acting reduced pressure, cell structures of the biogenic constituents are changed, membranes are torn open, and thus the enclosed biogenic mass is made available for the leaching process within a few minutes.

Also, cellulose and lignin compounds accessible for digestion only with difficulty are broken up by the above described action of temperature and vacuum and supplied to the subsequent biogas plant 20 (fermentation stage) as bio-potential.

Depending on temperature and thermal capacity of the suspension 74, the heat-up period in the boiling reactor 2 differs and may moreover be shortened substantially by pre-heating the added substances 1 and the process water 6 externally of the boiling reactor 2.

After the circulating water/process water 6 has been enriched to saturation with dissolved organic matter, the suspension 74 is discharged, and the thermally stabilized substrate/water mixture 10 is supplied to dehydration means 14 (here represented in the form of a classification press). In the dehydration means 14 the solid substance/press cake 22 is separated from the process water 18 enriched with organic matter. The press cake 22 may then be supplied to further process steps such as, e.g., composting, biological drying, or mechanical-thermal drying as exemplarily represented in FIG. 2.

The extraction process proper is dependent on input material and requires on the average between several minutes to more than an hour. Owing to the action of temperature over one hour, the suspension 74 is sanitized and may, after dehydration 14 and drying 42 (FIG. 2), be handled, stored, and supplied to further work steps without any objections in terms of human medicine.

The process water 8 is advantageously decontaminated in a biogas plant 20 (FIG. 8) wherein the organic matter proportion is converted to biogas 24 with the aid of methane bacteria, with the biogas then being supplied for energy generation in the heat generation plant 26, and the gas excess being supplied to further utilization 103 (FIG. 8) for generation of heat and electricity.

The decontaminated fermentation water 32 (FIG. 8) exits from the biogas plant 20 and is again supplied to the boiling extractor 2 as process water/circulating waster 6.

The exhaust vapor condensates 68 contain a major part of the nitrogen compounds which might inhibit the biological anaerobic decomposition process in the fermenter 20. Therefore the exhaust vapor condensates 68 are treated directly in an effluent purification 36 together with the excess water 34 (FIG. 8) and subsequently conducted into the sewer as purified effluent 105, or partly supplied to the boiling extraction process 2 as operating/process water 6. Through this reduction of nitrogen upstream of the biogas plant 20, the fermentation process does not require a nitrogen extraction any more.

Thus what is being represented is a method in which organically contaminated substances 1 are mixed and transported with water 6 in a reactor 2 by stirring mechanisms 8, and through thermal action 4 in the range of the boiling point of water under an applied vacuum the suspension 74 is digested in such a way that within a few minutes cell membranes are destroyed, lignin and cellulose compounds are broken up and made available to an anaerobic fermentation process in a biogas plant 20, so that the starting material 10 is thermally sanitized and following a dehydration step 14 and subsequent drying 42 (FIG. 2) may be handled, processed further and stored as a mixture of substances that is not problematic in terms of human medicine.

The superiority of the method of the invention may be seen from a comparison of the boiling extraction with other methods in which biogas is generated from the organic matter of residual waste having a 50% water

In the above described boiling extraction, the treatment period in the reactor 2 is 2 h at most with a circulating water quantity of 1000 l/kg residual waste, and the conversion into biogas in the fermenter 20 amounts to 5 days at most. As cellulose compounds are also partly decomposed, the gas production amounts to approx. 150 Nm³/1 Mg of residual waste. The methane content is 70%. The waste air quantity is approx. 1.0 m³/1 Mg of residual waste. The energy expenditure is approx. 5% of the energy yield at drying 15%.

In the percolation in accordance with patent applications EP 0876311 B1 and PCT/IB 99/01950 as described at the outset, the treatment period in the reactor is at least 2 days with a circulating water quantity of 3000 l/1 Mg of residual waste, and the conversion into biogas in the fermenter is 5 days at most. Cellulose compounds are not decomposed. The gas production is approx. 70 Nm³/1 Mg of residual waste. The methane content is 70%. The waste air quantity per 1 Mg of residual waste is approx. 1000 m³.

In the case of a residual matter fermentation in accordance with patent applications EP 9110 142 9.8 and EP 0192 900 B1, the treatment period in the gas reactor amounts to at least 20 days with a circulation amount of inoculant sludge of 20% of the total contents. 25 m³ capacity/volume are required for 1 Mg of supplied residual waste. Cellulose and lignin compounds are partly decomposed after a start-up period of 18 to 30 days. The gas production is approx. 100 Nm³/1 Mg of residual waste. The methane content is 55-60%. The waste air quantity for 1 Mg of residual waste is approx. 8000 m³, energy expenditure approx. 30% of the energy yield.

Another known extraction method is the pressure reduction explosion in which the tissue cells predominantly in the field of slaughterhouse wastes are kept in a pass-through autoclave at 350° C. and an overpressure of approx. 18 bars for two hours. After the holding time, a small amount is relaxed abruptly. Owing to the relaxation pressure the cell membranes are destroyed, and the slaughterhouse wastes may be supplied to a fermentation. The high temperatures and the holding time mainly serve for destroying the prions causing mad-cow disease (BSE). For 1 Mg of slaughterhouse wastes approx. 40 m³ of digestion tank volume are required. Lignin compounds are only partly decomposed. Gas production is approx. 300 Nm³/1 Mg of slaughterhouse wastes. The waste air quantity per 1 Mg is approx. 10.000 m³. Energy expenditure is approx. 50% of the energy yield.

FIG. 2 shows a minimum equipment for performing a vacuum boiling drying process for drying, stabilization and sanitation of substances such as, e.g.:

residual waste,

starting substance mixtures from boiling extraction, percolation

sludges from clarification plants and digested sludge from fermentation plants

products and wastes from the food industry

production sludges from the paint industry, chemical industry, and metal processing.

The humid material 1, 22, 60 is introduced into a boiling dryer 42 and moved, mixed and transported with the aid of a stirring device 8. The heat supply for reaching the boiling temperature is performed via the jacket heating 4. The process heat processing is in turn performed via the heat generation plant 26 whereby the heat energy 28 is generated in the form of warm water, pressurized hot water, thermo-oil or steam.

As the energy carrier 24 it is possible to utilize the autogenerated biogas from the boiling extraction process and/or also other fossil fuels or electric energy.

During boiling in the boiling dryer 42 the boiling point is held clearly lower than 100° C. by reduced pressure, and the jacket temperature 4 is adjusted—depending on humid material 1, 22, 60—to a temperature level such that encrustations do not occur on the heating surfaces, in order for the heat transfer being introduced into the humid material 1, 22, 60 in the absence of losses.

Operation of the boiling dryer 42 essentially corresponds to the operation of the boiling extractor 2 represented in FIG. 1, with the exception that no process water 6 is supplied. For the sake of clarity with regard to the basic functions of the boiling dryer 42, reference is made to the corresponding explanations concerning the boiling extractor 2.

Depending on entrance temperature and thermal capacity of the humid material 1, 22, 60, the heat-up period in the boiling dryer 42 differs and may also be shortened substantially by pre-heating of the humid material 1, 22, 60 externally of the boiling dryer 42 (device not represented). Following heating to operating temperature, the drying process proper lasts between 1.5 and 3 hours depending on the humidity of the humid material 1, 22, 60.

By the action of temperature at more than 90° C. over one hour holding time, the dry product 50 is then sanitized and may be handled, stored, and supplied to further work steps without any objections in terms of human medicine.

The dry product 50 exits from the boiling dryer 42 at an exit temperature of approx. 60 to 80° C. By means of the symbolically represented mass flow deflection 62 the warm dry matter 50 may be stored intermediately or processed further. If, however, a lower material temperature is desired for subsequent further treatment, the warm dry matter 50 is supplied to a cooling dryer 52. The cooling dryer 52 consists of a tight housing with an internally arranged, perforated transport belt 56 whereby the dry matter 50 (cake) is conveyed from entrance to exit.

The waste air 78 charged with heat and residual humidity from the dry matter 50 is cooled and dehumidified in a cooler/condenser 66. The condensate 68 is supplied to effluent treatment (FIG. 8). With the aid of a circulation fan 70 the cooled and dehumidified drying air 80 is conducted through the perforated transport belt 56 and the material cake 50. The cooled dry matter 72 exits from the cooling dryer 52 via a lock and delivery device not represented here. The air circuit 78, 80 is closed, with practically no waste air quantities or exhaust gases being engendered.

FIG. 3 shows a basic module 90 of a reactor usable as a boiling extractor 2 or as a boiling dryer 42. In this basic module 90 both functions such as boiling extraction 2 and boiling drying 42 may be performed. The centerpiece consists of the coreless conveying and circulating spiral 82 which concurrently assumes the stirrer function 8. By this circulating spiral 82 the contents 74, 76 are displaced gently, and by the material movement 100, 102 the heating surface 4 is kept free from encrustations, whereby the heat transfer from the heating medium 28 into the humid material to be heated or into the suspension 74 is ensured.

In summary this means that the constituents 74, 76 in nosh processes 2, 42, in combination with the stirring motion 100, 102 of the spiral 82, permanently clean off impurities from the heat exchanging surface of the reactor 2, 42, and owing to the geometry of the spiral 82, 8, ribbons strings or other long-fiber parts or substances cannot wind up or result in formation of tresses.

The circulating spiral 82 is moved by at least one drive mechanism 96, with a special sealing bush 98 preventing the entrance of leaked air. Through the inlet gate valve or the lock 84 the supply materials 1, 6, 22, 60 are supplied and, at the end of the processing time, the product 10, 50 is discharged via the outlet gate valve or the lock 88.

Due to the vacuum adjusted via the pumps 40, 44 (FIG. 1, is 2), the boiling point in the boiling extractor 2 or boiling dryer 42 is set to distinctly less than 100° C. and the exhaust vapors 46, 48 exit from the reactor 2, 42 (90) via a steam dome/exhaust vapor outlet 94. In order to shortly heat the suspension 74 to operating temperature in boiling extraction, steam 38 may be injected in addition to the jacket heating 92, 4.

FIG. 4 shows an embodiment including a stirring mechanism 106 with a central shaft and overlapping blades 107 which, during the rotation, owing to the propeller-type arrangement, keep the heating surfaces 92 of the reactor free from encrustations with the aid of the abrading humid materials 76 or of the suspension 74. The stirring mechanism 106 may also be heated by a heating medium 28 with blades 107 similar as in the previously known autoclaves for the manufacture of animal meal of slaughterhouse wastes or in disk-dryers for drying of sludges (not represented in the drawing).

In the preceding a device is explained for performing two methods, such as:

boiling extraction in accordance with FIG. 1

boiling drying in accordance with FIG. 2.

These two process steps may take place successively in one and the same device 90 without the constituents having to leave the reactor 90 in between the steps.

In large-scale plants it is, however, expedient if the steps are carried out in two separate process containers 2, 42, for the processes of boiling extraction 2 and boiling drying 42 have different dwell and treatment periods, and an intermediate dehydration step 14 reduces the amount of evaporation energy in terms both of energy and time.

FIGS. 5 to 6 show examples of exemplary arrangements of boiling extraction 2 and boiling drying 42.

FIG. 5 shows a reactor 90 which is intermittently charged 84 and discharged 88. The process material 74, 76 to be treated is moved back and forth (arrow 100) by the drive mechanism 96 through the stirring mechanism 106 until the process is terminated. This arrangement and manner of operating is particularly well suited for small-scale and single plants in which, e.g., two to three passages are performed in one day shift.

FIG. 6 shows a successive arrangement of several reactor stages or reactor sections wherein the single batches are continuously charged 84, treated and discharged 88. In order for the vacuum to be maintained during the shifting steps 102, the stages are separated from each other by gate valves or locks. Any desired number 90.1-90.m of single reactor portions maw be arranged in succession.

FIG. 7 shows an arrangement in which the process material 74, 76 to be treated circulates in a closed circuit. In accordance with this embodiment, two reactor sections 90.1, 90.2 having an approximately parallel arrangement are interconnected via shifting components 104. The two reactor sections 90.1, 90.2 each have a stirring mechanism 106 with a drive mechanism 96, with the conveying direction in the two sections 90.1, 90.2 being opposite (arrow 102).

Between the two sections 90.1, 90.2 the shifting components 104 are provided whereby the respective neighboring end portions of the sections 90.1, 90.2 are connected with each other, resulting in the represented circulation. The material to be processed is supplied via the material inlet 84 and discharged from the reactor via the material discharge 88.

Like in the arrangement in accordance with FIG. 1 it is here a matter of intermittent operation wherein, however, owing to the uniform rotation the process material may be conveyed through the devices (90.1, 90.2, 104) homogeneously (at the filling level expedient for the process).

The arrangement represented in FIG. 7 is suited for the throughput of large quantities which are handled, e.g., in several shifts and may practically be handled in continuous operation if at least three devices having the corresponding volume buffers are employed.

FIG. 8 shows a combination of the boiling extraction process in accordance with FIG. 1 and of the subsequent boiling drying process in accordance with FIG. 2 in combination with a biogas plant 20, an effluent purification plant 36, and a waste air treatment plant 30.

In the following the combinations and interconnections previously not treated in FIGS. 1 and 2 are described.

Residual waste matter or other organically contaminated waste substances 1 may optionally be supplied to boiling extraction 2 or also directly for drying to the boiling dryer 42. Pasty or liquid sludges 60 may be supplied directly to the boiling dryer 42 or as a Mixture 62 with the press cake 22 and residual waste 1 as added substances or as a single component.

The exhaust vapor 48, 46 occurring at the boiling dryer and at the boiling extractor 2 are supplied via the vacuum generator 40 to an upstream or downstream cooler/condenser 66 wherein the exhaust vapors 48, 66 are condensed out and separated from the exhaust gas 54. The condensate 68 is supplied to an effluent processing plant 36. The occurring exhaust gases are, depending on composition and proportion of contaminants, admixed to a waste air purification 30, or to the burner air supply for the heat generation plant 26 for post-combustion. The organically highly contaminated press water 18 from the extraction 2 is supplied to the biogas plant 20 for decontamination and biogas generation 24. The biogas 24 may then be supplied to other energy utilizations such as, e.g., to a thermoelectric coupling plant for power generation.

The decontaminated fermentation water 32 from the biogas plant 20 is resupplied to the extraction 2 as a leaching fluid 6 in the form of process water/circulation liquid. The excess water 34 from the biogas plant (fermentation) 20 is processed in the effluent treatment 36, jointly with the exhaust vapor condensate 68, and conducted into the sewer or into a draining ditch as purified effluent 105.

In order to save the heat-up energy in the form of fuels, there exists the possibility of shortly preadjusting the input flows 1, 60, 22 contaminated with organic matter to the desired operating temperature prior to introduction into the reactors (extractor, dryer) 90 in an intense retting box (feed container) 108 by gas application with air 110 or with technical oxygen 111 through biologically generated aerobic heating. Concurrently with the aerobic heating a biologically generated hydrolysis (acidificaton) takes place, wherein the leaching rate in the extraction 2 and the dehydration during drying 42 is increased substantially through biochemical digestion and enhanced biochemical availability in the subsequent treatment steps in the reactors 90.

In order for the waste air flow 54 to be kept as small as possible, particularly gas application with technically enriched oxygen 111 is suited. The waste air 54 is extracted from the feed containers (retting boxes) 108, and supplied to the prescribed waste air treatments 30, 26 for decontamination or combustion.

In the above described method for the treatment of organically contaminated residual waste 1 and other organically contaminated waste substances 22, 60, the water-containing cells of the membranes are torn open by the action of vacuums 46, 48 and heating 4, 26, 28, so that the cell water, like in the vacuum boiling extraction process (FIG. 1) in the boiling extractor 2, is available within a few minutes for washing out the organic matter constituents 18 and converted to biogas 24 in a biogas plant 20.

The same takes place in vacuum boiling drying (FIG. 2) in which the released cell water, together with the free water located at the surfaces of the wet material 76 to be dried, leaves the dryer 90 as exhaust vapor 46 by boiling under vacuum.

This cell digestion is hitherto being realized in the case of organically contaminated residual waste 1 and their mixture of substances 74, 76 by the following known method:

1. Biological digestion by acidificaton (hydrolysis) in the first phase of an aerobic composting process in which, by adjusting the following parameters such as:

humidity regulation

air supply

mechanical circulation

with the aid of bacterial action at optimum conditions, the cell digestion starts from the second treatment day and—depending on material composition—has reached the highest possible digestion rate between the third and fifth day.

2. Thermal-physical digestion

By heating in an autoclave to 120 to approx. 350° C. in the presence of an excess pressure from 2.0 to 15 bars with subsequent explosive pressure reduction in a reception and pressure reduction vessel. This process is referred to as pressure reduction explosion. In both methods the cell digestion is utilized in order to discharge the released cell water by leaching and convert it into biogas in a biogas plant. Following termination of the leaching process, the discharge material is in most cases supplied to a dehydration step, and the residual matter is composted and/or deprived of water in conventional thermal or biological drying.

In comparison with the above mentioned and already known methods 1 and 2, waste air flows worth mentioning are not engendered in boiling extraction 2 and boiling drying 42. At the most 1.0 m³ of waste air 54 per 1000 kg of supplied product 74, 76 is engendered. For the dehydration of 1000 kg via the exhaust vapor 46, 48, the thermal energy expenditure is 150 kWh at maximum, and the electrical energy expenditure is 10 kWh at maximum. Gas production in the treatment of 1000 kg residual waste, depending on organic matter proportion, is approx. 200 Nm³ of biogas or 1.300 kWh of thermal yield.

In the known methods 1 and 2 the highly contaminated waste air flow is approx. 3000 m³ per 1000 kg of product 74, 76. The thermal energy expenditure is at least 280 kWh, and the electric energy expenditure is an additional 24 kWh.

Disclosed are a method for processing residual waste and other organically contaminated waste substances, and a residual waste processing plant, wherein a waste substance containing organic constituents is heated to the boiling temperature range of water in a reactor under vacuum, so that membranes of water-containing cell structures are destroyed, and the organically highly contaminated cell water may be discharged together with the exhaust vapor.

1. A method for processing waste substances, wherein organic constituents of the waste substances are expelled in a reactor, comprising the steps of:
introducing the waste substances into the reactor
heating the waste substances under vacuum to a boiling temperature of water
applying shear forces to the waste substances received in the reactor via a stirring device; and
destroying membranes of water-containing cell structures of the organic constituents; and
expelling the engendered exhaust vapor containing organic constituents.

2. The method in accordance with claim 1, wherein, during a boiling extraction process, a-leaching fluid is supplied to the reactor functioning as a boiling extractor, and at least a proportion of the organic constituents is washed out with the leaching fluid and at least one of a group including a part of the organic constituents and bound nitrogen is expelled overhead with the generated exhaust vapor as ammonia.

3. The method in accordance with claim 2, wherein said boiling extraction process is followed by a boiling drying step.

4. The method in accordance with claim 1, wherein at least one of a group including a boiling drying process and a boiling extraction process is preceded by pre-heating the waste substance.

5. The method in accordance with claim 4, wherein the pre-heating step takes place through an aerobic retting process.

6. The method in accordance with claim 1, wherein the exhaust vapor is supplied to a condenser.

7. The method in accordance with claim 6, wherein leaked air generated during the process is burnt in a burner or supplied to a processing.

8. The method in accordance with claim 2, wherein organically contaminated leaching fluid is supplied to a biogas plant

9. The method in accordance with claim 8, wherein fermentation water decontaminated in the biogas plant is recycled to the boiling reactor as circulation or process water.

10. The method in accordance with claim 8, wherein the generated biogas is used for generating at least one of process heat and electrical energy.

11. The method in accordance with claim 1, wherein subsequently to a boiling drying process, a cooling drying process of the warm dry matters is performed.

12. The method in accordance with claim 3, wherein the boiling drying process and the boiling extraction process are performed in the same reactor.

13. A processing plant for processing waste substances containing organic constituents, the processing plant comprising:
a heatable reactor capable of being taken under vacuum to a boiling temperature of a leaching fluid; and
wherein said reactor includes a waste substances inlet, a material discharge, a vacuum port, a heating surface, an exhaust vapor outlet and a means for the introduction of shear forces.

14. A processing plant in accordance with claim 13, wherein the reactor is a boiling extractor having a leaching fluid inlet.

15. A processing plant in accordance with claim 13, wherein the reactor is a boiling dryer for dehydrating the waste substances.

16. A processing plant in accordance with claim 15, wherein a pre-heater is arranged upstream of the boiling dryer.

17. A processing plant in accordance with claim 14, further including a boiling dryer, wherein the boiling extractor and the boiling dryer are formed by the same reactor.

18. A processing plant in accordance with claim 14, including a biogas plant for processing of the contaminated leaching water.

19. A processing plant in accordance with claim 18, including a circulation means for recycling fermentation water occurring in the biogas plant as process water.

20. A processing plant in accordance with claim 15, further comprising a cooling dryer for post-drying of the warm dry matter.

21. A processing plant in accordance with claim 13, further comprising a condenser for the exhaust vapor.

22. A processing plant in accordance with claim 13, wherein the stirring mechanism has a stirrer through which the waste substances are conveyed from the inlet to the outlet.

23. A processing plant in accordance with claim 22, wherein the stirring mechanism has stirring members through which the material is stripped off an inner peripheral wall of the reactor.

24. A processing plant in accordance with claim 23, wherein the stirring element has the form of a worm gear with or without a center shaft.

25. A processing plant in accordance with claim 22, wherein the conveying direction of the stirring mechanism is reversible.

26. A processing plant in accordance with claim 22, wherein the stirring element is heated.

27. A processing plant in accordance with claim 14, wherein the waste substances inlet and the leaching fluid inlet have the form of a common inlet.

28. A processing plant in accordance with claim 13, further comprising a steam inlet for supplying heating steam.

29. A processing plant in accordance with claim 22, wherein the reactor has at least two sections in which a respective stirring mechanism is arranged.

30. A processing plant in accordance with claim 29, wherein the two sections are interconnected via shifting components so that the material is conveyed in the circulation.

31. A processing plant in accordance with claim 15, wherein a classification press is arranged downstream of the boiling dryer.

32. A processing plant in accordance with further comprising an effluent purification plant for processing effluent occurring during the process.

33. The method in accordance with claim 2, wherein the leaching fluid is water.

34. The method in accordance with claim 6, wherein said condenser is a cooler.

35. A processing plant in accordance with claim 13, wherein the leaching fluid is water.

36. A processing plant in accordance with claim 13, wherein the shear force means is a stirring mechanism.
